(19) United States
(12) Patent Application Publication
(10) Pub. No.: US 2022/0215271 A1
(43) Pub. Date: Jul. 7, 2022

(54) DETECTION DEVICE, DETECTION METHOD AND DETECTION PROGRAM

(71) Applicant: NIPPON TELEGRAPH AND TELEPHONE CORPORATION, Tokyo (JP)

(72) Inventors: Tetsuya SHIODA, Musashino-shi, Tokyo (JP); Miki SAKAI, Musashino-shi, Tokyo (JP); Masakuni ISHII, Musashino-shi, Tokyo (JP); Kazuki OIKAWA, Musashino-shi, Tokyo (JP)

(73) Assignee: NIPPON TELEGRAPH AND TELEPHONE CORPORATION, Tokyo (JP)

(21) Appl. No.: 17/608,480

(22) PCT Filed: May 9, 2019
(86) PCT No.: PCT/JP2019/018536

§ 371 Date: Nov. 3, 2021

(51) Int. Cl. G06N 5/02; G06N 5/04

(52) U.S. Cl. CPC G06N 5/022; G06N 5/04

(57) ABSTRACT

A detection device includes processing circuitry configured to compare data during learning and data during prediction for each feature amount of data and determine whether they are similar, and determine that accuracy of a model for outputting a predicted value of an objective variable of data has deteriorated when a ratio of a feature amount determined to be not similar to all feature amounts is equal to or greater than a predetermined threshold value.

### TECHNICAL FIELD

The present invention relates to a detection device, a detection method, and a detection program.

### BACKGROUND ART

Generally, in machine learning, during learning, the model is constructed by being trained using teacher data in which the value of an objective variable serving as a correct answer is given as correct answer data to the value of a feature amount which is an explanatory variable of the data collected in the past. Then, during prediction, when the value of the feature amount is input to the constructed model, the predicted value of the objective variable is output.

Here, a task in which the accuracy of a model deteriorates over time is present. For example, the accuracy of a task model including feature amounts representing human behavior and a task model using sensor data with seasonal fluctuations may deteriorate over time. In addition, the accuracy of a model such as traffic volume prediction may deteriorate due to external factors such as construction of new roads. In such a case, it is necessary to detect the deterioration of the accuracy of the model. Conventionally, the deterioration is detected by calculating the accuracy of the model using the correct answer data.

In addition, Non Patent Literature 1 discloses a technique for detecting a change in the tendency of data using numerical feature amounts of two pieces of data.

### CITATION LIST

### Non Patent Literature

[Non Patent Literature 1] Lee. J, Magoules. F, “Detection of Concept Drift for Learning from Stream Data”, 2012 IEEE 14th International Conference on High Performance Computing and Communication & 2012 IEEE 9th International Conference on Embedded Software and Systems, 2012, pp. 241-245

### SUMMARY OF THE INVENTION

### Technical Problem

However, in the conventional technique, it is difficult to detect the deterioration of the accuracy of the model. That is, it is difficult to prepare the correct answer data because the correct answer data does not exist during model operation and it takes a lot of operation to manually create the correct answer data.

The present invention has been made to solve the above-described problems, and an object thereof is to detect the deterioration of the accuracy of a model easily.

### Means for Solving the Problem

In order to solve the problems and attain the object, a detection device according to the present invention includes: a comparison unit that compares data during learning and data during prediction for each feature amount of data and determines whether they are similar; and a determination unit that determines that the accuracy of a model for outputting a predicted value of an objective variable of data has deteriorated when a ratio of a feature amount determined to be not similar to all feature amounts is equal to or greater than a predetermined threshold value.

### Effects of the Invention

According to the present invention, it is possible to detect the deterioration of the accuracy of a model easily.

### BRIEF DESCRIPTION OF DRAWINGS

FIG. 1 is a schematic diagram illustrating a schematic configuration of a detection device according to the present embodiment.

FIG. 2 is a diagram for describing a processing target of the detection device.

FIG. 3 is a diagram for describing the processing of a comparison unit.

FIG. 4 is a diagram for describing the processing of the comparison unit.

FIG. 5 is a flowchart illustrating a detection processing procedure.

FIG. 6 is a diagram illustrating an example of a computer that executes a detection program.

### DESCRIPTION OF EMBODIMENTS

Hereinafter, an embodiment of the present invention will be described in detail with reference to the drawings. However, the present invention is not limited to this embodiment. In the drawings, the same elements are denoted by the same reference numerals.

### Configuration of Detection Device

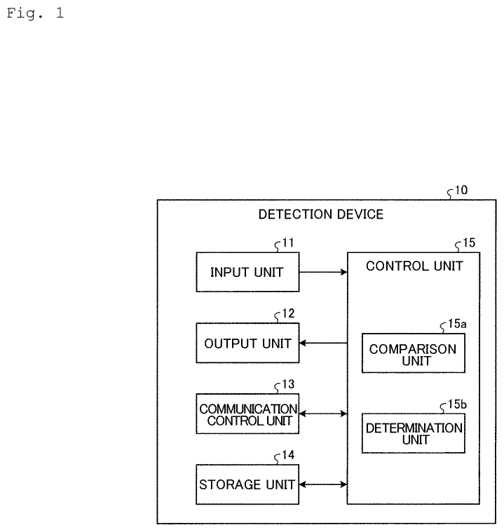

FIG. 1 is a schematic diagram illustrating a schematic configuration of a detection device of the present embodiment. As illustrated in FIG. 1, a detection device 10 of the present embodiment is realized by a general-purpose computer such as a personal computer, and includes an input unit 11, an output unit 12, a communication control unit 13, a storage unit 14, and a control unit 15.

The input unit 11 is realized using an input device such as a keyboard or a mouse and inputs various pieces of instruction information such as start of processing to the control unit 15 according to an input operation of an operator. The output unit 12 is realized as a display device such as a liquid crystal display and a printing device such as a printer. For example, the output unit 12 displays the result of the detection process described later.

The communication control unit 13 is realized by a NIC (Network Interface Card) or the like, and controls communication between an external device and the control unit 15 via a telecommunication line such as a LAN (Local Area Network) or the Internet. For example, the communication control unit 13 controls communication between the control unit 15 and a management device or the like that manages past data that is the target of the detection process described later.

The storage unit 14 is realized by a semiconductor memory element such as a RAM (Random Access Memory) or a flash memory (Flash Memory), or a storage device such as a hard disk or an optical disc. A processing program for operating the detection device 10, data used during execution of the processing program, and the like are stored in advance in the storage unit 14 or are stored temporarily each time the processing is performed. The storage unit 14 may be configured to communicate with the control unit 15 via the communication control unit 13.

For example, the storage unit 14 stores past data that is the target of the detection process described later. This data is collected from a management device or the like and stored in the storage unit 14 prior to the detection process described later. Note that these pieces of data are not limited to the case where they are stored in the storage unit 14 of the detection device 10, and may be collected, for example, when the detection process described later is executed.

The control unit 15 is realized using a CPU (Central Processing Unit) or the like, and executes a processing program stored in a memory. As a result, the control unit 15 functions as a comparison unit 15a and a determination unit 15b, as illustrated in FIG. 1. It should be noted that these functional units may be implemented in different hardware. Further, the control unit 15 may include other functional units. For example, the control unit 15 may include a collection unit that collects these pieces of information prior to the processing of the comparison unit 15a described later.

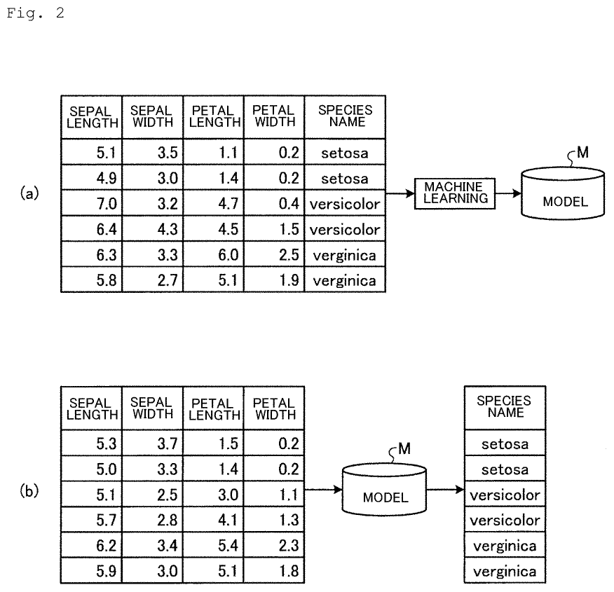

Here, FIG. 2 is a diagram for describing a processing target of the detection device 10. In machine learning, as illustrated in FIG. 2 (a), a model M is constructed by being trained using teacher data in which the value of the objective variable that is the correct answer is given as the correct answer data to the value of the feature amount that is the explanatory variable of the data collected in the past during learning.

In the example illustrated in FIG. 2 (a), the sepal length, the sepal width, the petal length, and the petal width are illustrated as the feature amounts of data. In addition, the objective variable is a species name, and the values of the objective variables such as “setosa” and “versicolor” are given to each piece of data as correct answer data.

Then, as illustrated in FIG. 2 (b), during prediction, when the value of the feature amount is input to the constructed model M, the predicted value of the objective variable is output. In the example illustrated in FIG. 2 (b), for example, when a sepal length of 5.3, a sepal width of 3.7, a petal length of 1.5, and a petal width of 0.2 are input to the model M, the predicted value “setosa” of the species name is output.

The detection device 10 of the present embodiment detects deterioration of the prediction accuracy of the model M by the detection process described later.

Returning to the description of FIG. 1, the comparison unit 15a compares the data during learning and the data during prediction for each feature amount of the data, and determines whether they are similar. Specifically, the comparison unit 15a compares the feature amounts represented by numerical values and the feature amounts represented by categories or text by different methods.

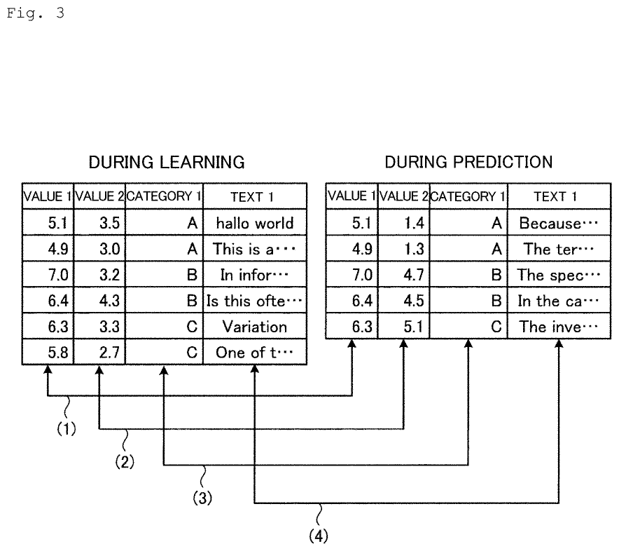

Here, FIG. 3 is a diagram for describing the processing of the comparison unit 15a. The comparison unit 15a compares the feature amounts represented by numerical values using, for example, the Kolmogorov-Smirnov test. That is, first, the comparison unit 15a normalizes each feature amount represented by a numerical value according to the range of the feature amount during learning. In the example illustrated in FIG. 3, the numerical values of the feature amounts “numerical value 1” and “numerical value 2” of each piece of data are normalized according to the range during learning.

Next, the comparison unit 15a compares the feature amount during learning and the feature amount during prediction for each feature amount represented by a numerical value using the Kolmogorov-Smirnov test, and calculates a p-value indicating the presence of a significant difference between two distributions as a test result. The p-value is a value indicating that the smaller the value, the greater the difference. Therefore, the comparison unit 15a determines that there is a significant difference, that is, both are not similar, when the p-value is equal to or less than a predetermined threshold value.

In the examples indicated by (1) and (2) in FIG. 3, the threshold value is 0.05, and the comparison unit 15a determines that the p-value of 0.9 with respect to the “numerical value 1” has no significant difference (similar) and determines that the p-value of 0.04 with respect to the “numerical value 2” has a significant difference (not similar).

Further, the comparison unit 15a compares the feature amounts represented by categories or text, for example, using a TF (Term Frequency)/IDF (Inverse Document Frequency) vector whose elements are the appearance frequency and rarity of each value of the feature amount. That is, the comparison unit 15a calculates the cosine similarity between the TF/IDF vector of the feature amount during learning and the TF/IDF vector of the feature amount during prediction for each of the feature amount “category 1” represented by category and the feature amount “text 1” represented by text illustrated in FIG. 3. Then, the comparison unit 15a determines that both are not similar when the calculated cosine similarity is equal to or less than a predetermined threshold value.

In the examples indicated by (3) and (4) in FIG. 3, the threshold value is set to 0.71, and the comparison unit 15a determines that the cosine similarity of 0.9 with respect to “category 1” is similar and determines that the cosine similarity of 0.6 with respect to “text 1” is not similar.

Returning to the description of FIG. 1, the determination unit 15b determines that the accuracy of the model M for outputting the predicted value of the objective variable of the data has deteriorated when the ratio of the feature amount determined to be not similar to all feature amounts is equal to or greater than a predetermined threshold value.

For example, in the example illustrated in FIG. 3, the threshold value is set to 0.5, and the determination unit 15b determines that the accuracy of the model M has deteriorated since the ratio of the two feature amounts “numerical value 2” and “text 1” determined to be not similar among the four feature amounts is calculated as 0.5. As a result of the detection process, the determination unit 15b may output the determination result to the output unit 12 or output the same to a management device or the like via the communication control unit 13.

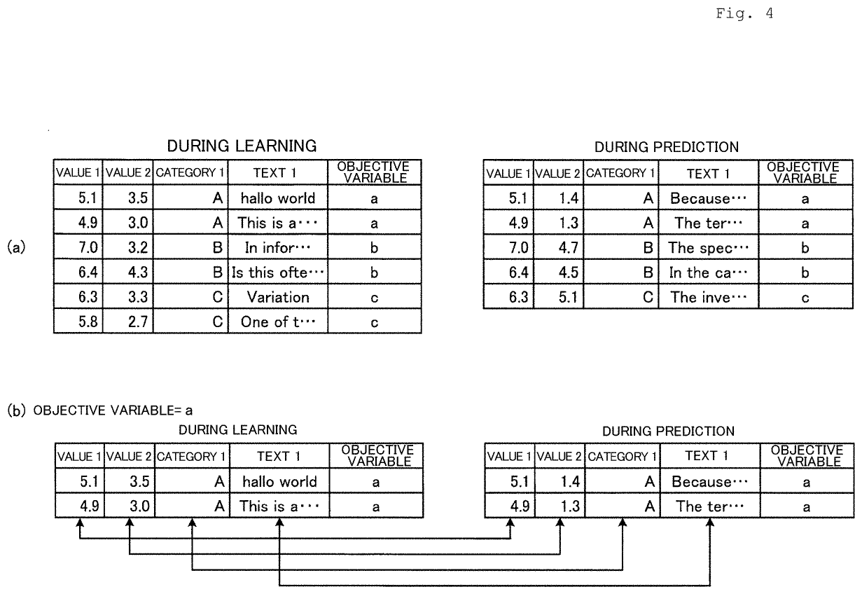

FIG. 4 is a diagram for describing the processing of the comparison unit 15a. As illustrated in FIG. 4, the comparison unit 15a may further compare the data during learning and the data during prediction for each value of the objective variable and determine whether they are similar.

That is, as illustrated in FIG. 4 (a), if there is the data during learning to which the correct answer data corresponding to the values “a”, “b”, and “c” of the objective variable of the prediction result is added, the comparison unit 15a can aggregate the data for each value of the objective variable. Therefore, as illustrated in FIG. 4 (b), the comparison unit 15a performs the same comparison as the method illustrated in FIG. 3 for each value of the objective variable, and determines whether the feature amounts are similar. In the example illustrated in FIG. 4 (b, the comparison unit 15a compares respective feature amounts with respect to the value “a” of the objective variable.

As a result, it is possible to detect changes when the properties of the data corresponding to a specific value of the objective variable are changed.

### Detection Process

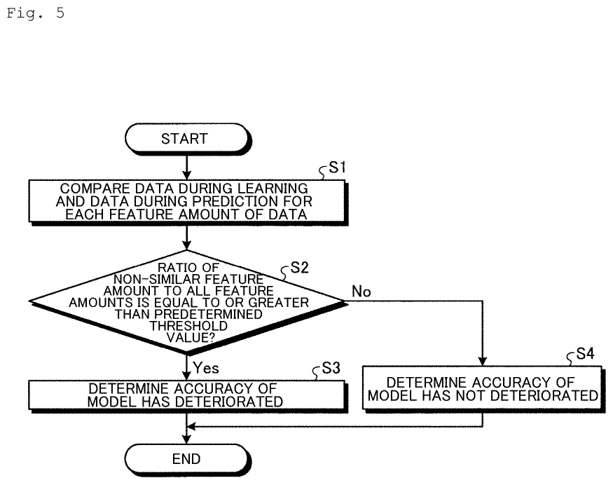

Next, the detection process by the detection device 10 according to the present embodiment will be described with reference to FIG. 5. FIG. 5 is a flowchart illustrating a detection processing procedure. The flowchart of FIG. 5 starts, for example, at the timing when the user inputs an operation of instructing the start.

First, the comparison unit 15a compares the data during learning and the data during prediction for each feature amount of the data, and determines whether they are similar (step S1). At that time, the comparison unit 15a compares the feature amounts represented by numerical values and the feature amounts represented by categories or text by different methods.

For example, the comparison unit 15a compares the feature amounts represented by numerical values using the Kolmogorov-Smirnov test. Further, the comparison unit 15a compares the feature amounts represented by categories or text using the TF/IDF vector.

Then, the determination unit 15b checks whether the ratio of the feature amounts determined to be not similar to all feature amounts is equal to or greater than a predetermined threshold value (step S2). When the ratio of the feature amounts determined to be not similar to all feature amounts is equal to or greater than a predetermined threshold value (step S2, Yes), the determination unit 15b determines that the accuracy of the model M for outputting the predicted value of the objective variable of the data has deteriorated (step S3).

On the other hand, when the ratio of the feature amounts determined to be not similar to all feature amounts is less than a predetermined threshold value (step S2, No), the determination unit 15b determines that the accuracy of the model M has not deteriorated (step S4). In this way, a series of detection processes ends.

As described above, in the detection device 10 of the present embodiment, the comparison unit 15a compares the data during learning and the data during prediction for each feature amount of the data, and determines whether they are similar. Further, when the ratio of the feature amounts determined to be not similar to all feature amounts is equal to or greater than a predetermined threshold value, the determination unit 15b determines that the accuracy of the model for outputting the predicted value of the objective variable of the data has deteriorated.

As a result, the detection device 10 can detect the deterioration of the accuracy of the model M of the task whose accuracy deteriorates over time using only the feature amount without using the correct answer data.

Specifically, the comparison unit 15a compares the feature amounts represented by numerical values and the feature amounts represented by categories or text by different methods. As a result, the detection device 10 can detect the deterioration in the accuracy of the model M using the feature amount without limiting the model M to either a numerical feature amount or a category and text-type feature amount without using correct answer data.

For example, it is possible to detect the deterioration of the accuracy of a task model M including a feature amount representing person's behavior such as a customer base, customer's tastes and behaviors, and fashion trends without using correct answer data. Further, it is possible to detect the deterioration of the accuracy of a task model M using the sensor data having seasonal fluctuations such as the characteristics of the sensor and the member changing depending on the temperature and humidity without using the correct answer data. In addition, it is possible to detect the deterioration of the accuracy of models such as traffic volume prediction due to external factors such as construction of new roads.

Further, the comparison unit 15a may further compare the data during learning and the data during prediction for each value of the objective variable and determine whether they are similar. As a result, the detection device 10 can detect the deterioration of the accuracy for each label value when the teacher data to which the correct answer data of the predicted label value is added so as to correspond to the data during prediction is prepared for the model M of the classification task. As a result, even when the property of the data of a specific label value changes, the change can be detected. As described above, according to the detection device 10, it is possible to easily detect the deterioration of the accuracy of the model M.

### Program

A program that describes processing executed by the detection device 10 according to the embodiment in a computer-executable language may be created. As an embodiment, the detection device 10 can be implemented by installing a detection program that executes the detection process as package software or online software in a desired computer. For example, by causing an information processing device to execute the detection program, the information processing device can function as the detection device 10. The information processing device mentioned herein includes a desktop or laptop-type personal computer. In addition, mobile communication terminals such as a smartphone, a cellular phone, or a PHS (Personal Handyphone System), and a slate terminal such as a PDA (Personal Digital Assistant) are included in the category of the information processing device. Furthermore, the functions of the detection device 10 may be implemented in a cloud server.

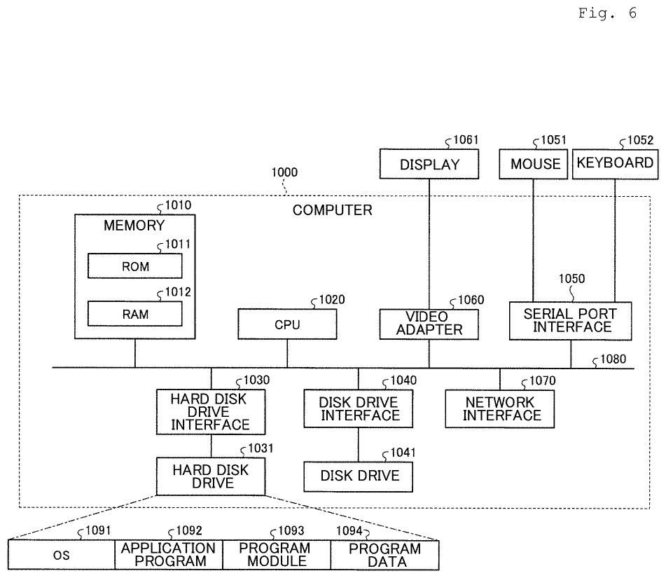

FIG. 6 is a diagram illustrating an example of a computer that executes the detection program. A computer 1000 includes, for example, a memory 1010, a CPU 1020, a hard disk drive interface 1030, a disk drive interface 1040, a serial port interface 1050, a video adapter 1060, and a network interface 1070. These elements are connected by a bus 1080.

The memory 1010 includes a ROM (Read Only Memory) 1011 and a RAM (Random Access Memory) 1012. The ROM 1011 stores a boot program such as a BIOS (Basic Input Output System), for example. The hard disk drive interface 1030 is connected to a hard disk drive 1031. The disk drive interface 1040 is connected to a disk drive 1041. A removable storage medium such as a magnetic disk or an optical disc is inserted into the disk drive 1041. A mouse 1051 and a keyboard 1052, for example, are connected to the serial port interface 1050. For example, a display 1061 is connected to the video adapter 1060.

Here, the hard disk drive 1031 stores an OS 1091, an application program 1092, a program module 1093, and program data 1094, for example. Various types of information described in the embodiment are stored in the hard disk drive 1031 and the memory 1010, for example.

The detection program is stored in the hard disk drive 1031 as the program module 1093 in which commands executed by the computer 1000 are described, for example. Specifically, the program module 1093 in which respective processes executed by the detection device 10 described in the embodiment are described is stored in the hard disk drive 1031.

The data used for information processing by the detection program is stored in the hard disk drive 1031, for example, as the program data 1094. The CPU 1020 reads the program module 1093 and the program data 1094 stored in the hard disk drive 1031 into the RAM 1012 as necessary and performs the above-described procedures.

The program module 1093 and the program data 1094 related to the detection program are not limited to being stored in the hard disk drive 1031, and for example, maybe stored in a removable storage medium and be read by the CPU 1020 via the disk drive 1041 and the like. Alternatively, the program module 1093 and the program data 1094 related to the detection program may be stored in other computers connected via a network such as a LAN (Local Area Network) or a WAN (Wide Area Network) and be read by the CPU 1020 via the network interface 1070.

While an embodiment to which the invention made by the present inventor is applied has been described, the present invention is not limited to the description and the drawings which form a part of the disclosure of the present invention according to the present embodiment. That is, other embodiments, examples, operation techniques, and the like performed by those skilled in the art based on the present embodiment fall within the scope of the present invention.

### REFERENCE SIGNS LIST

10 Detection device

11 Input unit

12 Output unit

13 Communication control unit

14 Storage unit

15a Control unit

15a Comparison unit

15b Determination unit

M Model

1. A detection device comprising:
processing circuitry configured to:
compare data during learning and data during prediction for each feature amount of data and determine whether they are similar; and
determine that accuracy of a model for outputting a predicted value of an objective variable of data has deteriorated when a ratio of a feature amount determined to be not similar to all feature amounts is equal to or greater than a predetermined threshold value.

2. The detection device according to claim 1, wherein the processing circuitry is further configured to perform the comparing for feature amounts represented by numerical values by a method, and perform the comparing for feature amounts represented by a category or a text by another method.

3. The detection device according to claim 1, wherein the processing circuitry is further configured to compare the data during learning and the data during prediction for each value of the objective variable and determines whether they are similar.

4. A detection method executed by a detection device, comprising:
comparing data during learning and data during prediction for each feature amount of data and determining whether they are similar; and
determining that accuracy of a model for outputting a predicted value of an objective variable of data has deteriorated when a ratio of a feature amount determined to be not similar to all feature amounts is equal to or greater than a predetermined threshold value.

5. A non-transitory computer-readable recording medium storing therein a detection program that causes a computer to execute a process comprising:
comparing data during learning and data during prediction for each feature amount of data and determining whether they are similar; and
determining that accuracy of a model for outputting a predicted value of an objective variable of data has deteriorated when a ratio of a feature amount determined to be not similar to all feature amounts is equal to or greater than a predetermined threshold value.
